(19) United States
(12) Patent Application Publication
(10) Pub. No.: US 2002/0177978 A1
(43) Pub. Date: Nov. 28, 2002

(54) Digital data acquisition system for manitoring and remote testing of gas and steam turbine performance parameters

(76) Inventors: Ryan E. Obenhoff, Scotia, NY (US); Steven E. Dahler, Ballston Spa, NY (US)

Correspondence Address: BANNER & WITCOFF, LTD., ATTORNEYS FOR GENERAL ELECTRIC, 1001 G. STREET, N.W., ELEVENTH FLOOR, WASHINGTON, DC, 20001-4597, US

(21) Appl. No.: 09/835,108

(22) Filed: Apr. 16, 2001

(51) Int. Cl. G06F 11/00; G06F 15/00

(52) U.S. Cl. 702/188

(57) ABSTRACT

A digital data acquisition system for monitoring and remote testing of gas and steam turbine performance parameters which is light weight, portable and can be quickly installed and configured. The system comprises a set of instrumentation modules, each containing digital transmitters, connected to a local computer for data processing and storage. The modules are linked together into a local digital network by a universal cable connection which reduces the number of unique parts used in conventional systems. The modules are also connected to a computer to process the digital signals and collect testing data. Once installed, remote performance testing and data acquisition is enabled by connecting the computer to a remote computer via a network or modem connection. Remote testing eliminates the need for the test engineer to travel to a site. Testing data may be made available for remote access by customers or other interested parties.

### BACKGROUND OF THE INVENTION

When gas or steam turbines are delivered and installed in a plant, it is typical to conduct a series of thermal performance tests to demonstrate that the equipment satisfies contractual requirements, diagnose potential performance shortfalls, and benchmark the efficiencies of various components and sections of the turbine. Any time after installation if any performance issues arise, a similar series of thermal performance tests may be conducted to determine any performance inefficiencies. The conventional testing method requires a test engineer to be on site during thermal performance testing to monitor the operating conditions of the turbine, often in hazardous conditions, and to collect precision thermal performance data from an array of testing equipment installed on the turbine. A preliminary performance analysis is conducted on site during commissioning to ensure data validity and accuracy of the results.

Performance testing is conducted by collecting analog signal outputs from multiple transmitters which are connected to pressure sensors for measuring pressures at various locations in the turbine. Some of the typical pressures which are measured during performance testing include the air flow, gas fuel, compressor discharge, differential pressures such as the inlet filter differential, exhaust pressure and atmospheric or barometric pressure. Any location in the turbine which is deemed necessary to monitor can be equipped with the necessary pressure sensor and transmitter. The analog signals from each of the transmitters are brought to a central, multiplexed analog-to-digital converter. The converted digital output signal is directed to a user interface. Because of the need for analog-to-digital conversion of the output signals, adding data channels requires purchase and set-up of additional converters. The equipment for conventional testing is bulky and thus adds to shipping costs and installation time.

Each individual transmitter may require unique cabling to connect it to an appropriate converter, and to connect to a power supply. Consequently, in a typical installation of these transmitters, the connections are a jumble of different unique cables which require longer set up and take down times.

In a conventional performance test using individual transmitters, the entire testing process is labor intensive and is estimated to take thirty days from the initial analysis of the test project and its development through conducting the test to completion of the test report. These thirty days includes seven days for developing the test procedure, and seven days for calibrating, packing and shipping the instrumentation; an additional three days for installation of instrumentation and site preparation; and another seven days for test data analysis and completion of a test report. The length of time required for data analysis and completion of the report is due to the necessity for analyzing and correlating separate results for each transmitter. Any time which is taken up by anything other than operation means lost revenue, and shortening the time for performance tests is always the goal in developing any test.

After initial compliance testing of a newly installed turbine, it may be desirable to conduct additional performance tests after certain operating intervals to ensure optimal efficiency. With the conventional testing equipment and procedures which require an interruption in production of up to thirty days, and the travel of a test engineer to the site to conduct the test, performance testing may be too costly for some power producers to conduct on a regular basis.

### SUMMARY OF THE INVENTION

The present invention relates to a digital data acquisition system for monitoring and remote testing of gas and steam turbine performance parameters which is digital, light weight, portable and can be quickly set up and configured in the field, and expanded as necessary. The present invention provides for small, light weight, self-contained transmitter clusters or modules which are quickly mounted to available fixtures at the testing location. A kit of multiple modules containing the necessary transmitters, organized in the modules in functional clusters, and are configured in a local, multidrop digital network by a universal cable connection. The network can be scaled to allow monitoring of multiple turbines at once. The modules are connected to a computer to collect the testing and performance data. Suitable software is provided to configure the network and record the transmitter outputs.

The digital transmitters eliminate the need for analog-to-digital conversion without sacrificing accuracy. Eliminating analog-to-digital converters from the list of required equipment also reduces packing and shipping costs. The digital transmitters in a module are wired together within the module so that each module is a self-contained component. The modules each have two identical electrical connectors to be connected with other modules or a power supply with a universal cabling that carries both power and data. Each of the connectors is a five pin bayonet twist connector having two power lines, one drain line and one shielded twisted data pair. Since one universal cable is used for both power and data transmission, the resulting module installation only has a single cable running from component to component, significantly reducing labor requirements and facilitating trouble shooting. The universal cable significantly reduces the number of unique parts required and simplifies the set up of the testing components. With the instrumentation of the present invention, the initial performance test which took thirty days with conventional equipment is estimated to take only thirteen days.

With the instrumentation installed, remote performance testing and data acquisition is enabled by connecting the on-site computer to a remote test engineer's computer via a network or modem connection. Remote testing eliminates the need for the test engineer to travel to a site as installation of the modules and connections with the universal cable can be done by an instrumentation technician or by on-site personnel. The test engineer can remotely start and stop the testing process and download the thermal performance data. Time saved by eliminating the travel required of a test engineer can instead be used for testing and analysis.

### BRIEF DESCRIPTION OF THE DRAWINGS

FIG. 1 is a schematic diagram of a digital data acquisition system showing a localized network of modules connected to an on-site computer that can be connected to a network to enable remote control and monitoring in accordance with the present invention.

FIG. 2 is an elevational view of a data acquisition transmitter module.

FIG. 3 is a bottom plan view of the module of FIG. 2.

FIG. 4 is a schematic wiring diagram of the internal wiring arrangement of the module of FIG. 2.

FIG. 5 is an elevational view of a multiple function cable and connectors for use with a module.

FIG. 6 is an end view of the key connector on the cable of FIG. 5.

FIG. 7 is an end view of the keyway connector on the cable of FIG. 6.

FIG. 8 is a section of the key connector taken along line 8-8 in FIG. 5.

FIG. 9 is a section of the keyway connector taken along line 9-9 in FIG. 5.

FIG. 10 is a flow diagram of a remote testing regimen employing the digital data acquisition system.

### DETAILED DESCRIPTION OF THE INVENTION

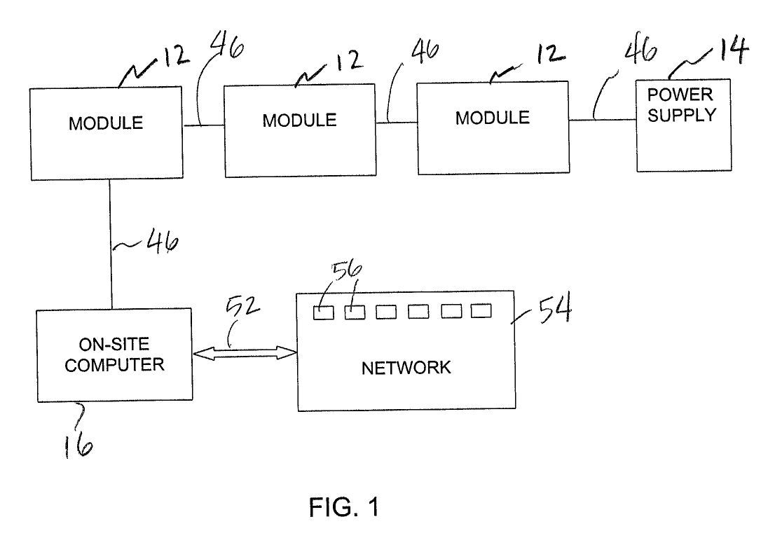

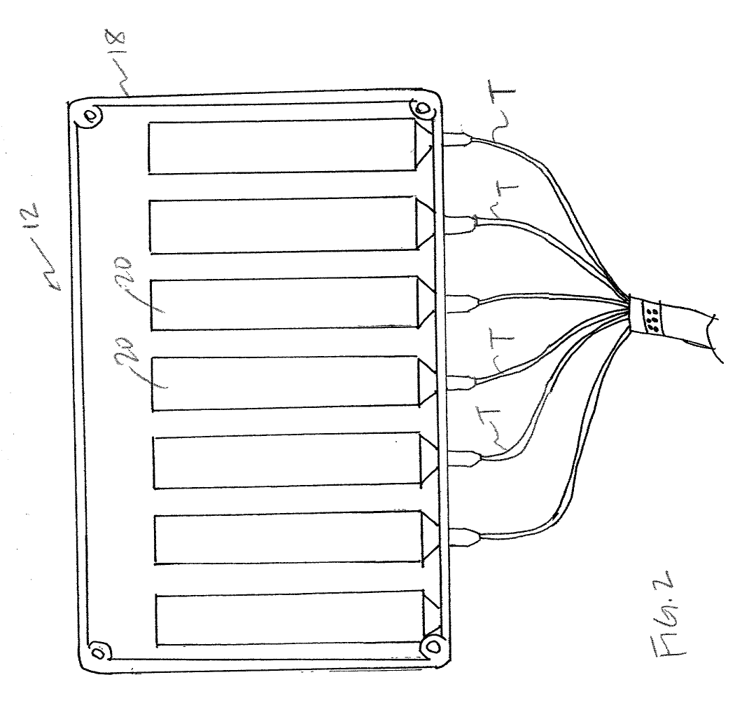

The building block of a digital data acquisition system 10 of the present invention is a module 12, a number of which are connected together in a local, multidrop digital network configuration with a power supply 14. This local network also includes an on-site computer 16 that is connected to the modules, FIG. 1. Each module 12 comprises a weather-tight housing 18 that contains a cluster of digital transmitters 20, shown schematically in FIG. 2. The housing has a cover that is attached with a suitable seal by screws or other fittings. Housing 18 in FIG. 2 is shown with the cover removed. The housing may also have suitable structures on the outer surface to enable the module to be mounted onto other equipment with nylon ties, or other supporting connectors. Each digital transmitter 20 is connected to a pressure transducer in a suitable tube fitting T that leads to a probe (not shown) in place at a particular location in the turbine to measure the pressure at a particular location in the turbine. In a preferred embodiment of digital data acquisition system 10, digital transmitters 20 are commercially available and provide a digital RS-485 output to computer 16. The local network shown in FIG. 1 is configured to allow monitoring performance parameters for a single turbine.

In a preferred embodiment, as shown in FIG. 1, three modules comprising one instrumentation kit are used to monitor the performance parameters for a single turbine. The three modules contains the necessary number of transmitters to collect data at an appropriate number of locations in the turbine. The transmitters are preferably grouped together within the modules in functional clusters. By simply adding modules to the chain, the local network can be scaled to allow monitoring of multiple turbines.

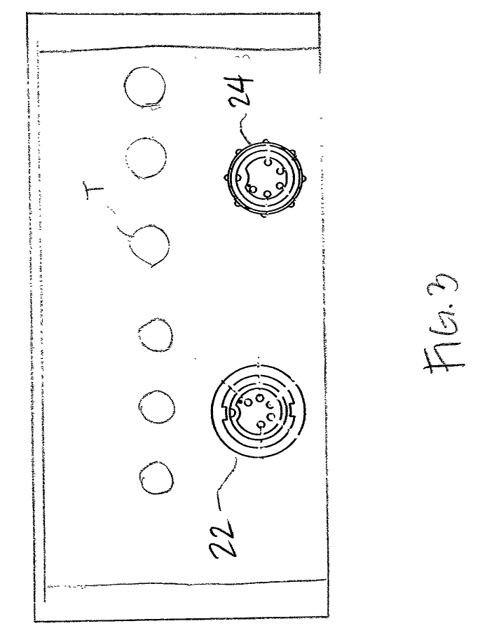

The connections between modules 12, power supply 14 and on-site computer 16 are accomplished with a single type of multi-function universal connector. This connector enables the instrumentation kits to be easily assembled together on site from a minimum of unique parts. Electrical connectors 22, 24 are disposed on the bottom wall of housing 18, FIG. 3. The wiring arrangement of the components inside of each module 12 is shown in FIG. 4. Electrical connectors 22, 24 are functionally equivalent, five pin bayonet twist connectors having two power lines 26, 28, a shield or drain line 30, and one shielded twisted data pair 32. One connector is preferably a key and the other is preferably a keyway. In the embodiment shown, the power lines are preferably 12 volts DC, and the twisted data pair preferably has characteristic impedance of 120 ohms. A diode bridge 34 is provided for polarity protection, as well as voltage transient diodes 36. Connectors 38, 40, 42, 44 are provided for connecting in digital transmitters.

Power supply 14 is provided in a housing similar to the instrument cluster with a corresponding wiring scheme and connectors so that the power supply module can be inserted anywhere in the local network chain. This provides added flexibility in setting up the test equipment.

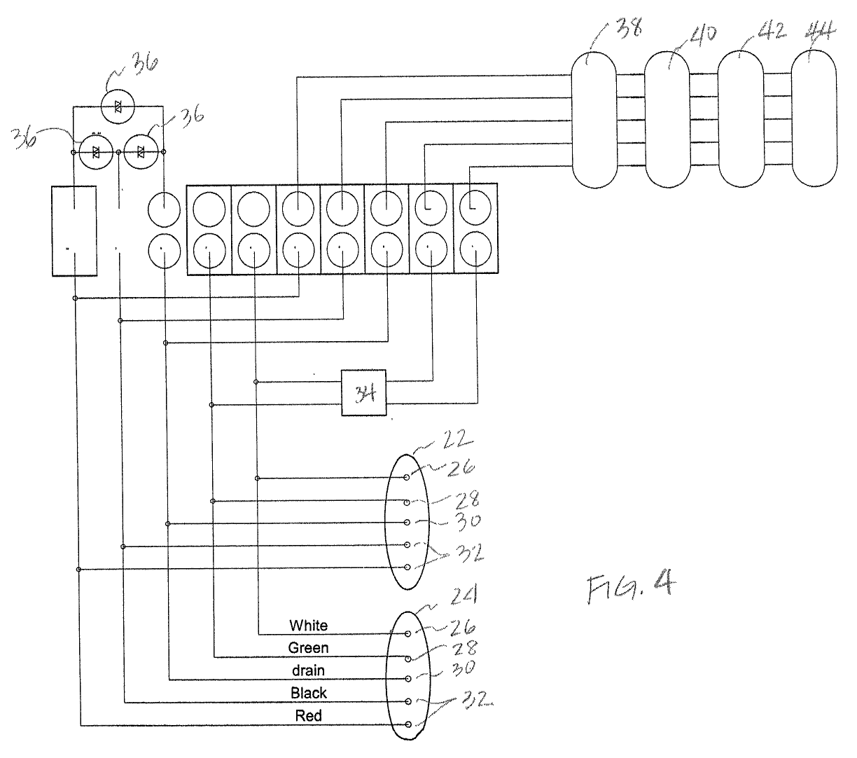

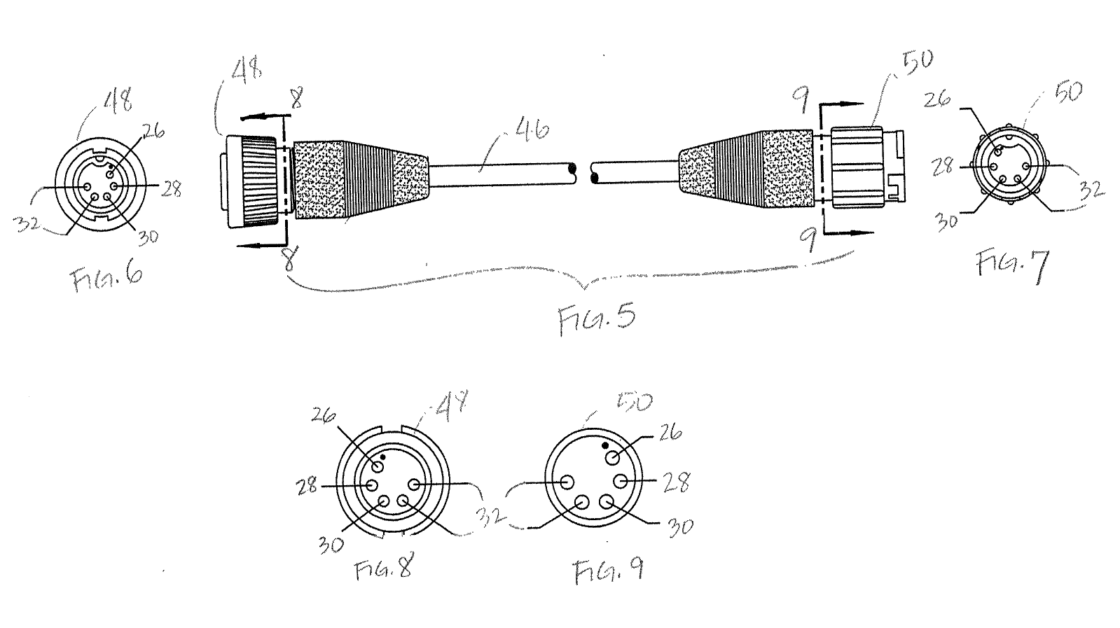

Modules 12 and power supply 14 are connected together and to computer 16 by universal cable 46 which allows for quick connect and disconnect of the components. Universal cable 46 is terminated with a key connector 48 and a keyway connector 50 configured to couple with connectors 22, 24 of the modules or power supply. A detailed illustration of cable 46 is shown in FIGS. 5-9. FIGS. 6 and 8 show key connector 48 and FIGS. 7 and 9 show keyway connector 50. When the modules and power supply are networked together, key connector 48 of cable 46 is plugged into a respective keyway connector in the module or power supply, and keyway connector 50 of cable 46 is coupled to the key connector in the module or power supply. Cable 46 and its connectors enables the grouping of transmitters 20 installed in any one module 12 to be linked with the computer by a single cable. Also, in this manner, any number of modules and power supply components can be chained together with only a single cable. This greatly reduces the number of cables and connectors necessary to install the instrumentation, reduces the set-up time, and eliminates the confusion of multiple cables and wires for each individual transmitter as required in conventional instrumentation arrays.

The local network, FIG. 1, is terminated on one end by a terminating cap that plugs into one of electrical connectors in a module, while the other end is connected to on-site computer 16 running software for data acquisition, such as PDQlink. On-site computer 16 has a connection 52, depicted by a two-way arrow via either modem or network. Network 54 that on-site computer connects to may be any type of network, wide area or distributed, such as an intranet or the internet. Network 54 comprises multiple remote computers 56.

The digital transmitters used in acquisition system 10 of the present invention completely eliminates the need for an analog-to-digital converter and of course for calibrating analog signal conditioners. A single module of the present invention is similar in size to a single, individual transmitter that is used in convention testing. Moreover, in the preferred instrumentation kit of three modules, those modules contain a total of thirteen transmitters. Instead of requiring space for thirteen individual transmitters, the instrumentation kit of the present invention now requires the space equivalent of three individual transmitters. The savings in packing and freight are significant. Also, instead of separate wiring to an analog-to-digital converter and user interface from each individual transmitter, the present invention now connects together the three modules with only a single multi-function cable 46.

Due to the ease of set-up of the digital instrumentation kit of the present invention, once the modules are locally networked together as shown in FIG. 1, the thermal performance test can be conducted remotely from network 54. This eliminates the need for a test engineer to travel to the test site. Instead, the data acquisition modules 12 are installed by a technician or on-site personnel, and a series of checks are conducted to verify that the units are in proper operating condition. A test engineer at a remote location can connect a remote computer 56 to on-site computer 16 via connection 52 and actuate the data acquisition system to begin thermal performance testing. The test engineer is in contact with site personnel to ensure the unit is maintained in proper operating conditions throughout the duration of the test. After completion of the test, the test engineer will remotely stop the data acquisition system and download the precision thermal performance data from on-site computer or other data storage. The test engineer will then be able to conduct the analysis of the data and formulate conclusions.

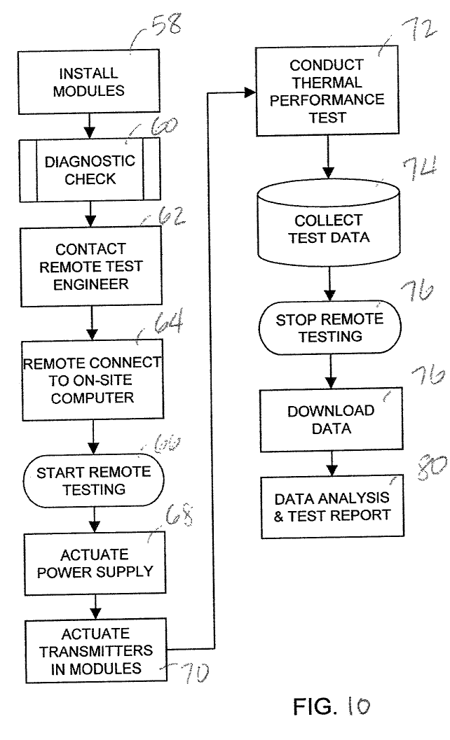

A flow diagram of the remote testing regimen is shown in FIG. 10. After installation of the modules (58), a diagnostic check (60) is conducted by on-site personnel. Once the diagnostic check passes, the on-site personnel contact the test engineer (62) who is in a remote location. The test engineer connects to the on-site computer 16 via a modem or network connection (64) and can then start remote testing (66). The power supply for the modules is actuated 68, and then the transmitters are actuated (70). The test engineer conducts the thermal performance test (72) and the test data is collected (74) by the on-site computer into an appropriate storage device. When the remote test is stopped (76) the test engineer downloads the collected test data (78) remotely. The last step is to analyze the test data and complete a test report (80).

The remote testing enables customers and other interested parties to have on-line access to the test data. Such a remote viewer would be provided with any security information they need to access the web page to view the test results. A web page may be designed to enable a remote viewer to provide real time input to the test engineer about the test and data, and to confirm compliance with contractual requirements and performance test codes.

It is also contemplated that the need for installation of the system can be eliminated and the digital data acquisition system be incorporated into the standard instrumentation package that is shipped with the gas or steam turbine to the customer.

Such an integrated system would of course, even further reduce the labor to conduct thermal performance testing.

A comparison of the time required for some primary processes in conventional thermal performance testing versus thermal performance testing with the instrumentation of the present invention is shown in the following table.

| | Current | Estimated |
|---|---|---|
| Process Step | Estimate | Goal |
| Project analysis and test development | 3 days | 3+ days |
| Develop test procedure | 7 days | 2 days |
| Develop instrumentation lists | 1 day | <1 day |
| Calibrate, pack and ship instrumentation | 7 days | 2 days |
| Site preparation | 3 days | 1 day |
| Conduct test and demobilize site | 2 days | 2 days |
| Develop test report | 7 days | 2 days |
| TOTAL | 30 days | 13 days |

The 17 days difference between the time required for a conventional test and the remote test of the present invention represents a significant cost differential. The savings due to the elimination of required travel for performance evaluation personnel and corresponding loss of productivity must be added to this as well. In all, an extremely labor and time intensive testing procedure can be reduced by more than 50% with the present invention.

One of the advantages of the invention is the ability to provide customers and others interested with immediate access to the test and test data. As discussed above, the test data can be displayed on a web page in real time so that a remote viewer can provide immediate real time feedback, and confirm compliance of the turbine for thermal performance. Alternatively, various storage methods can be used to store the test data for viewing with a time delay. The video can also be stored on a portable medium such as a tape or disk which can easily be forwarded to a remote user or archived in a library.

Thus has been described a digital data acquisition system for thermal performance testing of turbines after installation and remote performance The foregoing explanation includes many variations and embodiments, and the invention is not intended to be limited to the specific details disclosed herein, but only by the claim appended hereto.

What is claimed is:

1. A digital data acquisition system for monitoring and remote testing of turbine performance parameters, said system comprising:
a digital transmitter to be in contact with a corresponding pressure transducer; and
an instrumentation module including a housing for containing said digital transmitter therein, said module adapted to be connected to a computer for data collection.

2. The system of claim 1 comprising a plurality of said digital transmitters housed in said module and wired to a module keyway connector.

3. The system of claim 2 further comprising a module key connector.

4. The system of claim 3 comprising a plurality of said modules each containing at least one of said digital transmitters, said modules connected together by a cable connecting corresponding ones of said module key connectors to said module keyway connectors.

5. The system of claim 4 further comprising a power supply module having a module keyway connector and module key connector, said power supply module connected to one of said modules by a cable connecting said power supply module key connector to the module keyway connector of said one of said modules.

6. The system of claim 5 wherein a chain of said modules are connected to each other and terminated at one end by a terminating cap and at another end by a cable connecting said chain of modules to a computer for data acquisition.

7. The system of claim 6 wherein said computer has connectivity to another network.

8. The system of claim 1 wherein a chain of said modules are connected to each other and terminated at one end by a terminating cap and at another end by a cable connecting said chain of modules to a computer for data acquisition.

9. The system of claim 8 wherein said computer has connectivity to another network.

10. A digital data acquisition system for monitoring and remote testing of turbine performance parameters, said system comprising:
a plurality of digital transmitters each adapted to be in contact with a corresponding pressure transducer;
a plurality of instrumentation modules connected together by cables, each said module including a housing for containing some of said digital transmitters therein and each said module adapted to be connected to a computer for digital signal processing and data collection;
a power supply module connected to one of said modules by a cable; and
wherein said computer is adapted to be connected to another network.

11. The system of claim 10 wherein each instrumentation module comprises a module output connector and a module input connector.

12. A method for remote thermal performance testing of a gas or steam turbine, said method comprising the steps of:
providing an array of digital transmitters in contact with corresponding pressure transducers with probes arranged in various locations in the turbine;
connecting the digital transmitters together and to a local computer;
connecting the local computer to a network; and
conducting thermal performance testing from a remote computer connected to the network.

13. The method of claim 12 further comprising the step of collecting testing data from the transmitters in a data storage device.

14. The method of claim 13 further comprising the step of downloading the testing data upon completion of the thermal performance testing.

15. The method of claim 14 further comprising the step of correlating the testing data into a usable format.

16. The method of claim 15 further comprising the step of providing secure access to the testing data via the network to a remote user.

17. The method of claim 16 further comprising the step of enabling input from the remote user via the network.

18. A digital data acquisition system for monitoring and remote testing of turbine performance parameters, said system comprising:
a plurality of instrumentation modules each comprising a housing and a pair of functionally equivalent electrical connectors for transmitting power and data;
at least one digital transmitter mounted in each of said modules, said transmitter electrically coupled to said connectors;
a power supply module comprising a pair of functionally equivalent electrical connectors; and
said instrumentation modules and said power supply module connected together and to a computer, said computer adapted for digital signal processing and test data collection.

19. The system of claim 18 wherein said connectors each comprise a pair of power leads, a twisted data pair of leads and a drain lead.

20. An instrumentation module for a digital data acquisition system for monitoring and remote testing of turbine performance parameters, said module comprising:
a weather-tight housing;
a pair of functionally equivalent electrical connectors in said housing; and
at least one digital transmitter disposed in said housing and electrically coupled to said connectors.

21. The module of claim 20 wherein one of said connectors is a key connector.

22. The module of claim 20 wherein one of said connectors is a keyway connector.

23. The module of claim 20 wherein each of said connectors comprises a pair of power leads, a twisted data pair of leads and a drain lead.
